(19) United States
(12) Patent Application Publication
(10) Pub. No.: US 2012/0210554 A1
(43) Pub. Date: Aug. 23, 2012

(54) APPARATUS AND METHOD FOR PICKING UP AND MOUNTING BARE DIES

(75) Inventor: Jung-Il HAN, Incheon (KR)

(73) Assignee: SAMSUNG TECHWIN CO., LTD., Kyongsangnam-do (KR)

(21) Appl. No.: 13/241,797

(22) Filed: Sep. 23, 2011

(30) Foreign Application Priority Data
Feb. 23, 2011 (KR) 10-2011-0015996

(51) Int. Cl. B23P 11/00; B23P 19/00

(52) U.S. Cl. 29/428; 29/700

(57) ABSTRACT

Provided are an apparatus and method for picking up and mounting parts. The apparatus includes: a first pickup unit including a plurality of first suction nozzles which pick up parts from a first substrate by sucking the parts; a flipper comprising a rotary driving member which rotates the first pickup unit such that a surface of each of the parts sucked by the first suction nozzles faces toward one direction; and a second pickup unit including a plurality of second suction nozzles which pick up the parts sucked by the first suction nozzles of the first pickup unit rotated by the flipper by sucking the parts and mount the picked-up parts on a second substrate.

### CROSS-REFERENCE TO RELATED PATENT APPLICATION

This application claims priority from Korean Patent Application No. 10-2011-0015996 filed on Feb. 23, 2011 in the Korean Intellectual Property Office, the disclosure of which is incorporated herein by reference in its entirety.

### BACKGROUND

1. Field

Apparatuses and methods consistent with exemplary embodiments relate to picking up and mounting bare dies, and more particularly, to increasing the number of bare dies that are processed by supplying bare dies directly to a mounter, and thus, shortening the distance traveled by the parts.

2. Description of the Related Art

Generally, a wafer is a thin, circular disk obtained by slicing a cylindrical silicon ingot to make the silicon crystal into semiconductor chips. Hundreds of bare dies, which are unit elements, are provided on a wafer.

Bare dies are sucked and separated from a wafer by nozzles, transported for a subsequent process such as die bonding, and then made into semiconductor chips.

FIG. 1 is a plan view of a related art apparatus for picking up and mounting bare dies.

The apparatus shown in FIG. 1 is widely used in a flip-chip process. Thus, the apparatus will be referred to as a flip chip mounter 1 for ease of description.

The flip chip mounter 1 includes a wafer stage 2 which is located in the region of a die feeder and on which a wafer (not shown) is placed, an ejector 3 which is located under the wafer stage 2 and pushes up bare dies (not shown) provided on the wafer, a cassette elevator 4 which supplies a stack of wafers to the wafer stage 2, a plurality of motors 5 which deliver driving power, a gripper 6 which grips and moves a frame or a part, a die picker 7 which sucks bare dies from a wafer, a flipper 8 which helps the movement of the die picker 7, a die shuttle 9 which moves the bare dies to a position at which the bare dies are to be picked up by nozzles (not shown) of a head 11, a shuttle conveyor 10 which moves a substrate (or a board or a printed circuit board (PCB)), and the head 11 which sucks the bare dies moved by the die shuttle 9 and mounts the bare dies on the substrate (PCB).

In the related art flip chip mounter 1, the die picker 7 separates bare dies from a wafer, and the die shuttle 9 moves the bare dies. Then, the head 11 picks up the bare dies placed on the die shuttle 9, and mounts the picked-up bare dies on the substrate. That is, bare dies have to go through a number of stages before finally being mounted on the substrate. Therefore, the bare dies are highly likely to move out of place or be damaged during the stages.

In addition, since the die shuttle 9 moves the bare dies placed thereon, the work time increases, resulting in a reduction in production efficiency. Further, while the die shuttle 9 moves, the die picker 7 and the head 11 have to stop and wait.

### SUMMARY

One or more exemplary embodiments provide an apparatus and method for picking up and mounting parts, the apparatus and method employed to increase the number of parts that are processed by directly supplying the parts without via any intermediate mediums and thus shortening the distance traveled by the parts. The parts may be bare dies formed on a wafer.

One or more exemplary embodiments also provide an apparatus for picking up and mounting parts, which has an improved structure to increase work efficiency and productivity, and a method of picking up and mounting the parts.

However, these exemplary embodiments are not limited to those set forth herein.

According to an aspect of an exemplary embodiment, there is provided an apparatus for picking up and mounting parts, the apparatus including: a first pickup unit including a plurality of first suction nozzles which pick up parts from a first substrate by sucking the parts; a flipper including a rotary driving member which rotates the first pickup unit so that a surface of each of the parts sucked by the first suction nozzles faces toward one direction; and a second pickup unit including a plurality of second suction nozzles which pick up the parts sucked by the first suction nozzles of the first pickup unit rotated by the flipper by sucking the parts and mount the picked-up parts on a second substrate.

According to an aspect of another exemplary embodiment, there is provided a method of picking up and mounting parts, the method including: picking up parts from a first substrate by sucking the parts using a first pickup unit; rotating the first pickup unit using a flipper such that a surface of the parts faces upward; picking up the parts rotated by the flipper by sucking the parts using a second pickup unit; and mounting the picked-up parts on a second substrate using the second pickup unit.

### BRIEF DESCRIPTION OF THE DRAWINGS

The above and other aspects will become more apparent by describing in detail exemplary embodiments thereof with reference to the attached drawings, in which:

FIG. 1 is a plan view of a related art apparatus for picking up and mounting bare dies;

FIG. 2 is a perspective view of an apparatus for picking up and mounting bare dies according to an exemplary embodiment;

FIGS. 3A and 3B are partial enlarged perspective views of the apparatus shown in FIG. 2, according to an exemplary embodiment;

FIGS. 4A through 4E are diagrams illustrating the process of using the apparatus shown in FIG. 2, according to an exemplary embodiment;

FIG. 5 is a flowchart illustrating a method of picking up and mounting bare dies according to an exemplary embodiment;

FIGS. 6 through 8 are detailed flowcharts illustrating the method of FIG. 5, according to an exemplary embodiment; and

FIG. 9 is a flowchart illustrating a method of picking up and mounting bare dies according to another exemplary embodiment.

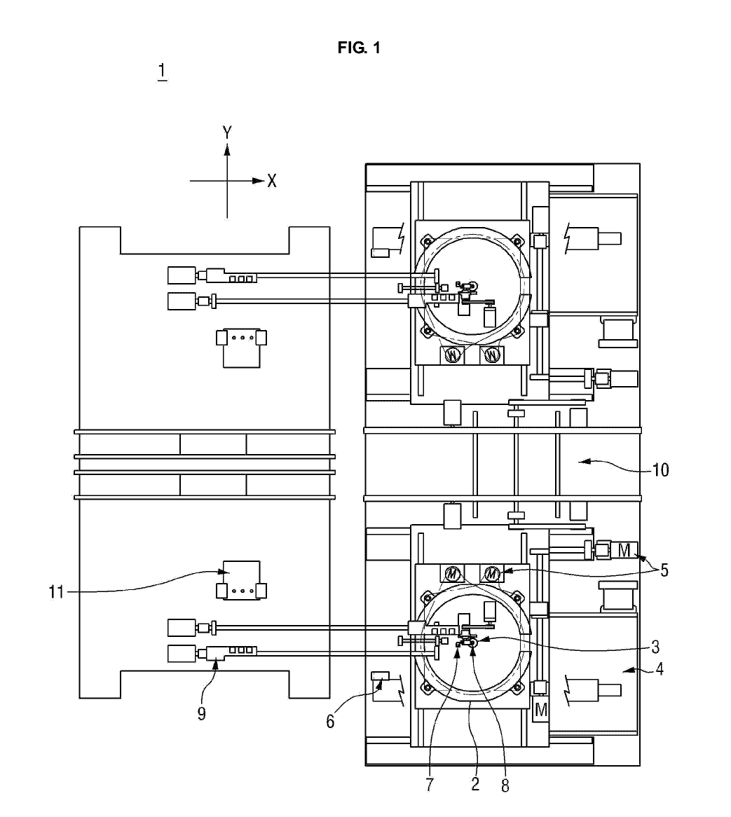

### DETAILED DESCRIPTION OF EXEMPLARY EMBODIMENTS

The inventive concept will now be described more fully hereinafter with reference to the accompanying drawings, in which exemplary embodiments are shown. This exemplary embodiments may, however, be changed or modified in different forms and should not be construed as limited thereto set forth herein. Rather, these exemplary embodiments are provided so that this disclosure will be thorough and complete, and will filly convey the scope of the inventive concept to those skilled in the art. The same reference numbers indicate the same components throughout the specification. In the accompanying drawings, the thickness of layers and regions is exaggerated for clarity.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the inventive concept.

The terminology used herein is for the purpose of describing particular exemplary embodiments only and is not intended to be limiting of the exemplary embodiment. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, but do not preclude the presence or addition of one or more other components.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the inventive concept will be described more fully with reference to the accompanying drawings.

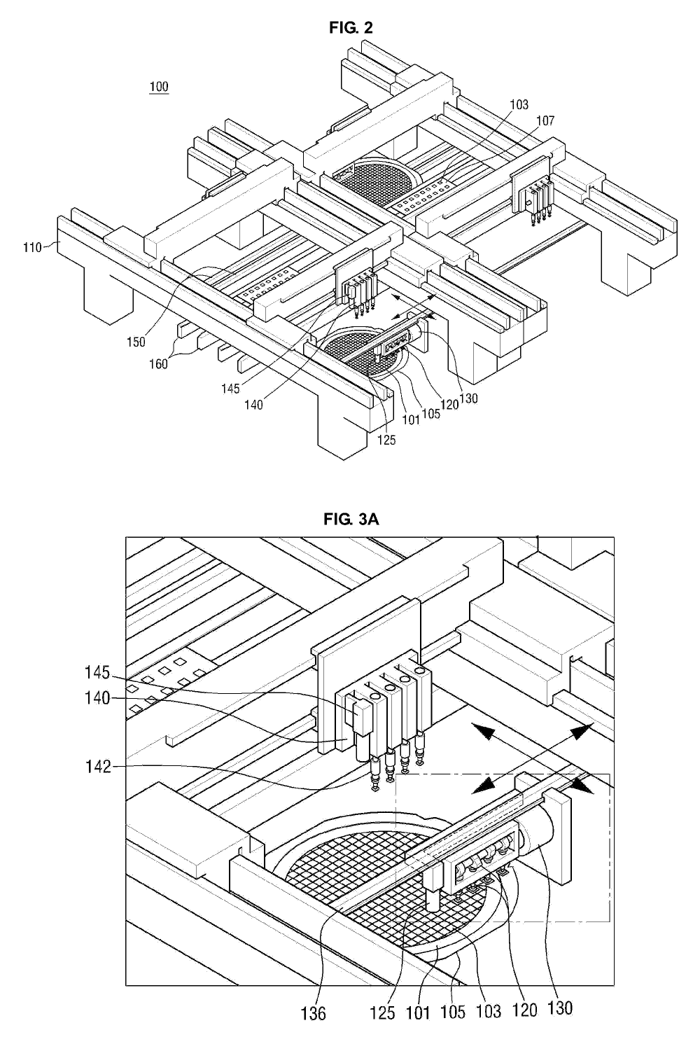

FIG. 2 is a perspective view of an apparatus 100 for picking up and mounting bare dies according to an exemplary embodiment.

Referring to FIG. 2, the apparatus 100 according to the current exemplary embodiment supplies a plurality of bare dies 103 on a wafer 101 directly to a substrate 107 by using first and second pickup units 120 and 140. Here, the bare dies 103 include not only parts provided on the wafer 101 but also all parts that can be picked up by the apparatus 100.

The apparatus 100 includes the first pickup unit 120, a flipper 130, and the second pickup unit 140. The apparatus 100 further includes a frame 110 on which the first pickup unit 120, the flipper 130 and the second pickup unit 140 are installed, a wafer stage 105 on which the wafer 101 is placed, a wafer shuttle 150 which moves the wafer 101, and a substrate shuttle 160 which moves the substrate 107 mounted thereon.

Specifically, the first pickup unit 120, the flipper 130, the second pickup unit 140, etc. are installed on the frame 110. The frame 110 allows the first pickup unit 120 and the second pickup unit 140 to make gantry motions on an X-Y plane.

The wafer shuttle 150 moves the wafer 101 placed thereon to a position, at which the bare dies 103 are to be picked up, within a predetermined linear section. The substrate shuttle 160 moves the substrate 107 placed thereon within a section in which the bare dies 103 can be mounted on the substrate 107.

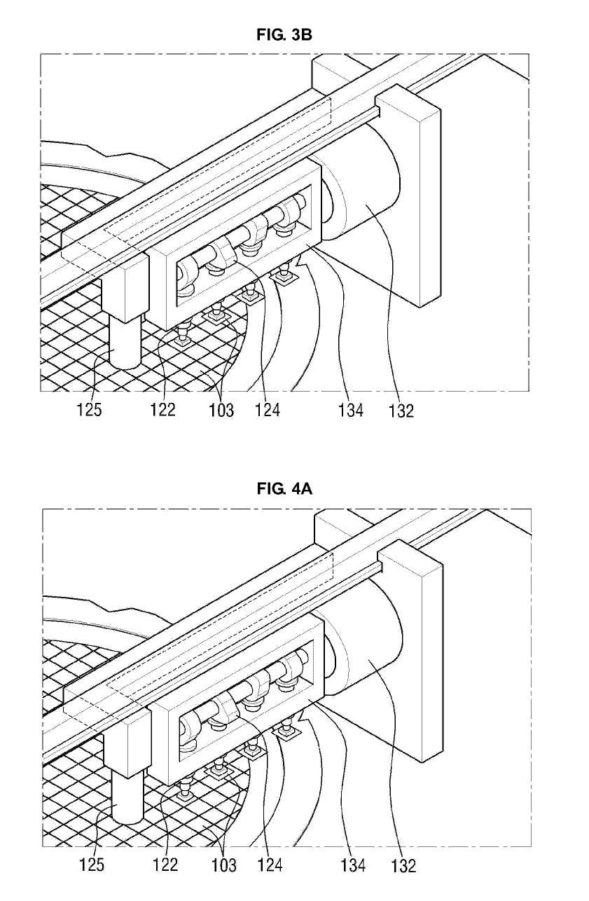

The first pickup unit 120 includes a plurality of first suction nozzles 122 (as shown in FIG. 3B) which pick up the bare dies 103 from the wafer 101 by sucking the bare dies 103.

The flipper 130 includes a rotary driving member 132 (as shown in FIG. 3B) and rotates the first pickup unit 120 using the rotary driving member 132 so that a surface of each of the bare dies 103 sucked by the first suction nozzles 132 of the first pickup unit 120 faces toward one direction. For example, a surface of each of the bare dies 103 sucked by the first suction nozzles 132 of the first pickup unit 120 faces upward by the rotary driving member 132.

The second pickup unit 140 includes a plurality of second suction nozzles 142 which pick up the bare die 103 from the first suction nozzles 122 of the first pickup unit 120 rotated by the flipper 130 by sucking the bare dies 103 and mount the picked-up bare dies 103 on the substrate 107.

In FIG. 2, the process of sucking the bare dies 103 from the wafer 101 and mounting the sucked bare dies 103 on the substrate 107 is performed in two areas. However, the exemplary embodiment is not limited thereto.

FIG. 3A is a partial enlarged perspective view of the apparatus 100 shown in FIG. 2. FIG. 3B is a partial enlarged perspective view of the first pickup unit 120 and the flipper 130.

Referring to FIGS. 3A and 3B, the first pickup unit 120 includes the first suction nozzles 122 and a plurality of cams 124. The first suction nozzles 122 pick up the bare dies 103 from the wafer 101 by sucking the bare dies 103. The cams 124 rotate to move the first suction nozzles 122 up and down. That is, as the cams 124 rotate, the first suction nozzles 122 make a reciprocating motion in a vertical direction.

The cams 124 are connected respectively to the first suction nozzles 122 so as to enable the first suction nozzles 122 to operate individually. That is, since the cams 124 situated above the first suction nozzles 122 are connected respectively to the first suction nozzles 122 and operate individually, the first suction nozzles 122 can suck the bare dies 103 at different times.

The first pickup unit 120 may further include a first detection module (not shown) which can detect positions of the wafer 101 and the bare dies 103 provided on the wafer 101. Using the first detection module, the first pickup unit 120 placed above the wafer 101 can accurately detect the positions of the bare dies 103. Examples of the first detection module include a camera and an optical system.

The flipper 130 includes the rotary driving member 132, a housing 134, and a linear driving member 136.

The housing 134 accommodates the cams 124 therein and is rotated by the rotary driving member 132.

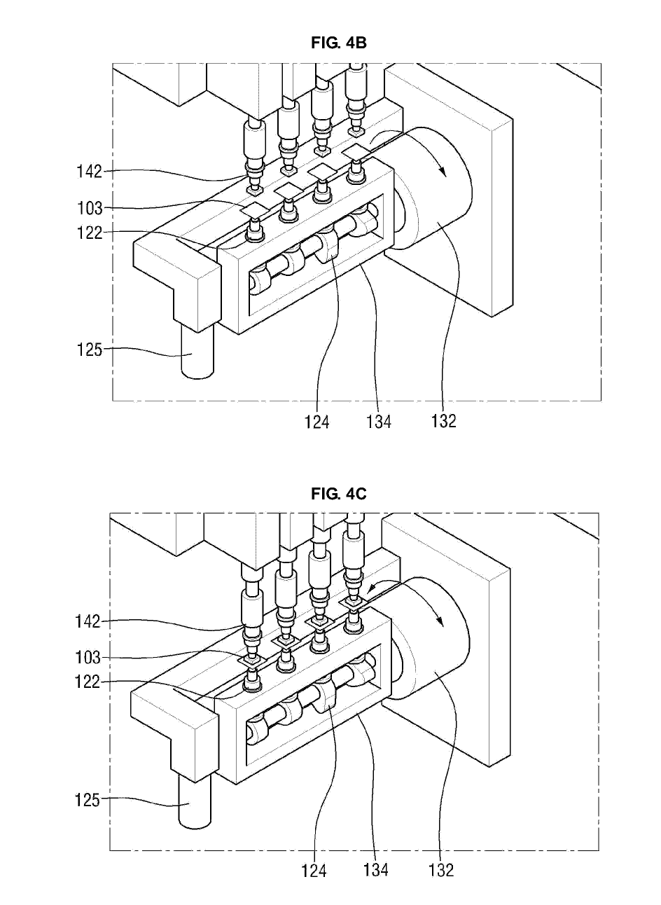

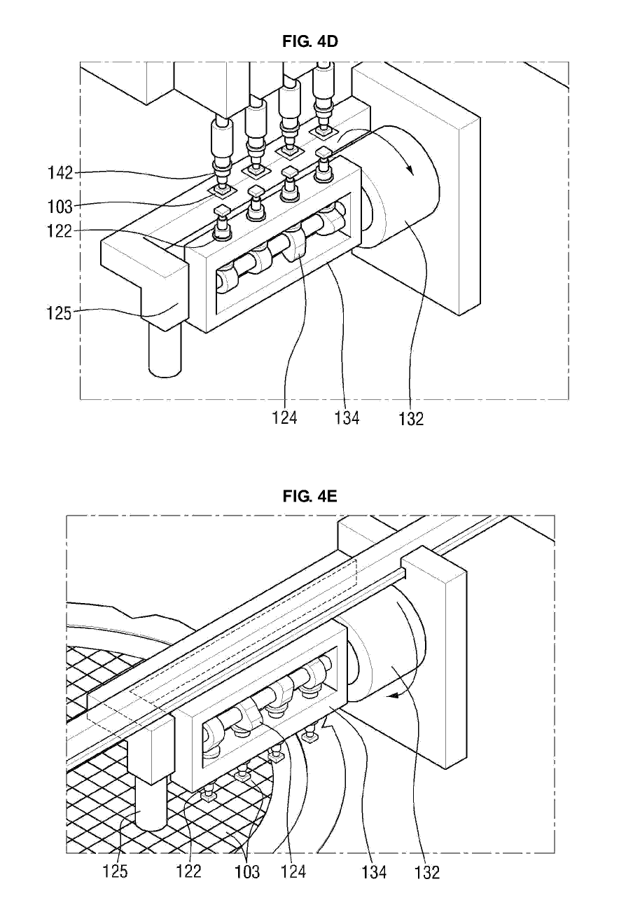

The rotary driving member 132 rotates the housing 134, thereby rotating the cams 124 and the first suction nozzles 122 of the first pickup unit 120. Therefore, bottom surfaces of the bare dies 103 sucked by the first suction nozzles 122 are made to face upward by the rotation of the rotary driving member 132, as will be further described later in reference to FIG. 4B.

Since the flipper 130 includes the linear driving member 136, the first pickup unit 120 can move orthogonally on the X-Y plane. The linear driving member 136 of the flipper 130 enables the first pickup unit 120 to flexibly suck and pick up the bare dies 103 from the wafer 101 moved by the wafer shuttle 150.

The apparatus 100 further includes a driving unit (not shown) which moves the flipper 130 up and down. The first pickup unit 120 moves up and down corresponding to move of the flipper 130 by the driving unit.

The second pickup unit 140 includes the second suction nozzles 142. The second pickup unit 140 may further include a second detection module (not shown) which detects the substrate 107 and the bare dies 103 sucked by the first suction nozzles 122.

As described above, the second suction nozzles 142 pick up the bare dies 103 from the first suction nozzles 122 of the first pickup unit 120 rotated by the flipper 130 by sucking the bare dies 103 and mount the picked-up bare dies 103 on the substrate 107, as will be further described later in reference to FIG. 4B.

The second detection module is provided in the second pickup unit 140 for accurate sucking, picking up and mounting of the bare dies 103. The second detection module detects the positions of the bare dies 103 sucked by the first suction nozzles 120 and a region of the substrate 107 on which the bare dies 103 are to be mounted. Like the first detection module of the first pickup unit 120, the second detection module of the second pickup unit 140 may be a camera, an optical system or the like.

FIGS. 4A through 4E are diagrams illustrating the process of using the apparatus 100 of FIG. 2. The process of using the apparatus 100 will now be described with reference to FIGS. 4A through 4E.

Referring to FIG. 4A, as the cams 124 arranged at equal intervals in the first pickup unit 120 rotate, the first suction nozzles 122 connected respectively to the cams 124 make a reciprocating motion in the vertical direction.

The first suction nozzles 122 suck and pick up a set of bare dies 103 from the wafer 101 by vacuum pressure. Here, the first pickup unit 120 accurately identifies a position at which the bare dies 103 are to be sucked by using the first detection module (not shown). Once all of the first suction nozzles 122 suck the bare dies 103, the cams 124 rotate until the first suction nozzles 122 arrive at their preset starting points.

The position at which the bare dies 103 are to be sucked is determined by a direction in which the wafer 101 is transferred and an orthogonal motion of the linear driving member 136 of the flipper 130. However, these factors are not the only ones that determine the position. For example, the position at which the bare dies 103 are to be sucked may be determined by the transferring direction of the wafer 101 and the linear motion of the linear driving member 136 of the flipper 130.

Referring to FIG. 4B, after all of the first suction nozzles 122 of the first pickup unit 120 suck and pick up the bare dies 103, the wafer 101 is transferred in a direction by the wafer shuttle 150. It is obvious to those skilled in the art that another first pickup unit 120 is installed in an area to which the wafer 101 is transferred and picks up another set of bare dies 103.

Next, the rotary driving member 132 of the flipper 130 rotates 180 degrees to make the bottom surfaces of the bare dies 103 sucked by the first suction nozzles 122 face upward. Here, the cams 124 are fixed to the housing 134, and the vacuum pressure of the first suction nozzles 122 holds the bare dies 103 in position.

Referring to FIG. 4C, the second pickup unit 140 approaches the first pickup unit 120 by moving orthogonally on the X-Y plane. Using the second detection module (not shown), the second pickup unit 140 detects the positions of the bare dies 103 sucked by the first suction nozzles 122. Then, the second suction nozzles 142 of the second pickup unit 140 descend and dock with the first suction nozzles 122 of the first pickup unit 120.

Referring to FIG. 4D, after vacuum pressure of the second suction nozzles 142 is generated, the vacuum pressure of the first suction nozzles 122 is released. The second pickup unit 140 moves to above the substrate 107 by moving orthogonally on the X-Y plane, detects a region of the substrate 107 on which the bare dies 103 are to be mounted by using the second detection module, and then mounts the bare dies 103 on the substrate 107.

Referring to FIG. 4E, the flipper 130 rotates 180 degrees again, and the wafer 101 is transferred again to its original position. Then, the first pickup unit 120 picks up yet another set of bare dies 103 from the wafer 101.

FIG. 5 is a flowchart illustrating a method of picking up and mounting bare dies according to an exemplary embodiment.

Referring to FIG. 5, the first pickup unit 120 picks up the bare dies 103 from the wafer 101 by sucking the bare dies 103 (S510), and the flipper 130 rotates the first pickup unit 120 so that a surface of each of the bare dies 103 faces upward (S520). Then, the second pickup unit 140 picks up the bare dies 103 rotated by the flipper 130 by sucking the bare dies 103 (S530) and mounts the picked-up bare dies 103 on the substrate 107 (S540).

The first pickup unit 120 includes the first suction nozzles 122, and the second pickup unit 140 includes the second suction nozzles 142. Thus, the first pickup unit 120 and the second pickup unit 140 can simultaneously pick up a plurality of bare dies from the wafer 101.

In addition, the bare dies 103 sucked by the first pickup unit 120 are rotated 180 degrees by the flipper 130.

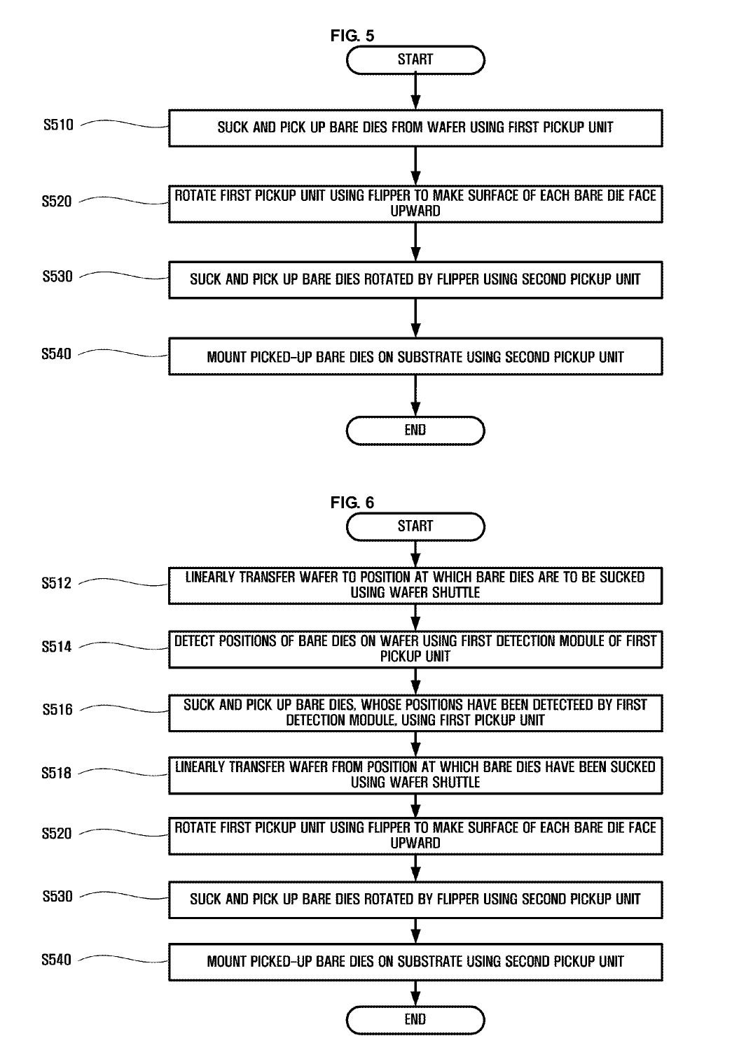

FIGS. 6 through 8 are detailed flowcharts illustrating the method of FIG. 5. The method of FIG. 5 will now be described in greater detail with reference to FIGS. 6 through 8.

Referring to FIG. 6, for the first pickup unit 120 to pick up (a set of the bare dies 103 from the wafer 101 by sucking the bare dies 103 (510), the wafer shuttle 150 linearly transfers the wafer 101 to a position at which the bare dies 103 are to be sucked by the first pickup unit 120 (S512), and the first detection module (not shown) of the first pickup unit 120 detects positions of the bare dies 103 provided on the linearly transferred wafer 101 (S514). Then, the first pickup unit 120 picks up the bare dies 103, whose positions have been detected, from the wafer 101 by sucking the bare dies 103 (S516), and the wafer shuttle 150 linearly transfers the wafer 101 from the position at which the bare dies 103 have been picked up by the first pickup unit 120 (S518), so that another first pickup unit 120 can suck and pick up another set of the bare dies 103.

Referring to FIG. 7, for the second pickup unit 140 to pick up the bare dies 103 rotated by the flipper 130 by sucking the bare dies 103 (S530), the second pickup unit 140 moves to above the first pickup unit 120 (S532), and the second detection module (not shown) of the second pickup unit 140 detects the positions of the bare dies 103 sucked by the first pickup unit 120 (S534). Then, the second pickup unit 140 picks up the bare dies 103 from the first pickup unit 120 by sucking the bare dies 103 (S536).

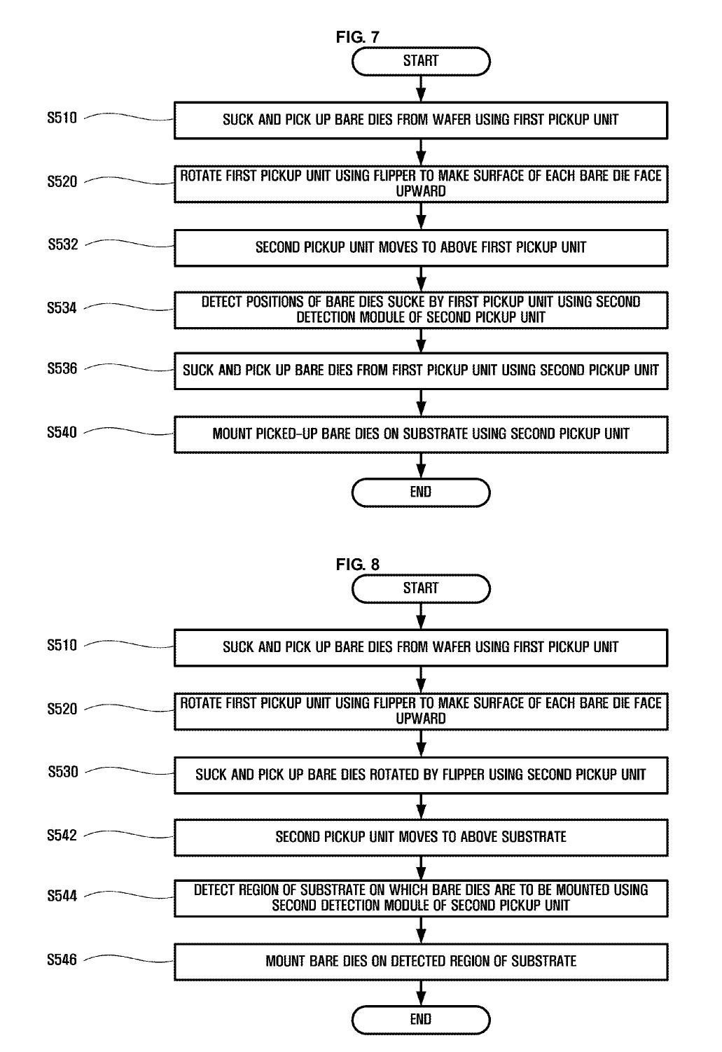

Referring to FIG. 8, for the second pickup unit to mount the picked-up bare dies 103 on the substrate 107 (S540), the second pickup unit 140 moves to above the substrate 107 (operation S542), and the second detection module (not shown) of the second pickup unit 140 detects a region of the substrate 107 on which the bare dies 103 are to be mounted (operation S544). Then, the second pickup unit 140 mounts the bare dies 103 on the detected region of the substrate 107 (operation S546).

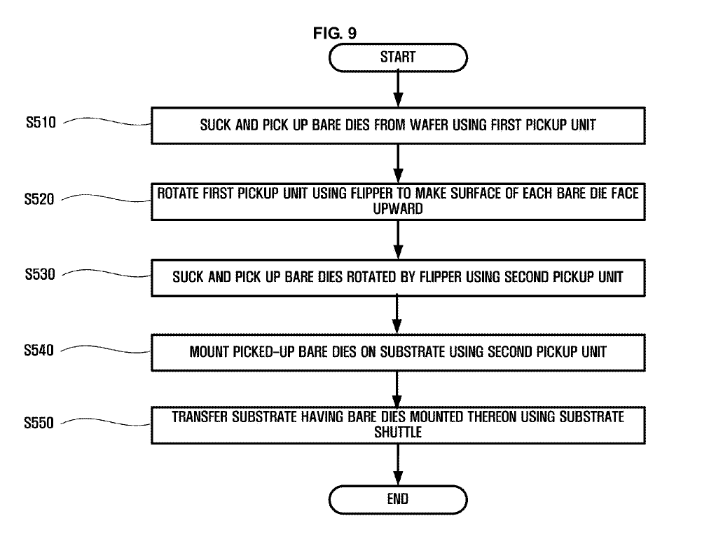

FIG. 9 is a flowchart illustrating a method of picking up and mounting bare dies according to another exemplary embodiment.

Referring to FIG. 9, the first pickup unit 120 picks up the bare dies 103 from the wafer 101 by sucking the bare dies 103 (S510), and the flipper 130 rotates the first pickup unit 120 such that a surface of each of the bare dies 103 faces upward (S520). Then, the second pickup unit 140 picks up the bare dies 103 rotated by the flipper 130 by sucking the bare dies 103 (S530) and mounts the picked-up bare dies 103 on the substrate 107 (S540). After the bare dies 103 are mounted on the substrate 107, the substrate 107 is transferred by the substrate shuttle 160 (S550).

Thereafter, the apparatus 100 for picking up and mounting successively installed bare dies mounts the bare dies 103 on the substrate 107, or an operation to be performed after the mounting of the bare dies 103 on the substrate 107 is completed is executed.

According to the exemplary embodiments, bare dies are supplied directly to a substrate without via any intermediate mediums for transporting the bare dies. Thus, the work time can be reduced, while work efficiency is increased.

Since the bare dies are mounted directly on the substrate without going through a number of stages, they can be prevented from moving out of place or being damaged.

In addition, since the distance traveled by the bare dies is shortened, the number of bare dies that are processed increases, which, in turn, maximizes productivity.

In concluding the detailed description, those skilled in the art will appreciate that many variations and modifications can be made to the exemplary embodiments without substantially departing from the principles of the inventive concept. Therefore, the disclosed exemplary embodiments are used in a generic and descriptive sense only and not for purposes of limitation.

What is claimed is:

1. An apparatus for picking up and mounting parts, the apparatus comprising:
a first pickup unit comprising a plurality of first suction nozzles which pick up parts from a first substrate by sucking the parts;
a flipper comprising a rotary driving member which rotates the first pickup unit so that a surface of each of the parts sucked by the first suction nozzles faces toward one direction; and
a second pickup unit comprising a plurality of second suction nozzles which pick up the parts sucked by the first suction nozzles of the first pickup unit rotated by the flipper by sucking the parts and mount the picked-up parts on a second substrate.

2. The apparatus of claim 1, further comprising a first shuttle which moves the first substrate placed thereon within a predetermined linear section.

3. The apparatus of claim 1, wherein the first pickup unit comprises a plurality of cams which rotate to move the first suction nozzles up and down.

4. The apparatus of claim 3, wherein the cams correspond respectively to the first suction nozzles, and the first suction nozzles are operated individually by the rotation of the cams.

5. The apparatus of claim 1, wherein the first pickup unit comprises a first detection module which detects positions of the parts provided on the first substrate.

6. The apparatus of claim 1, wherein the flipper comprises a linear driving member which moves the first pickup unit to position the first pickup unit above the first substrate.

7. The apparatus of claim 1, wherein the second pickup unit comprises a second detection module which detects positions of the parts sucked by the first suction nozzles and a region of the second substrate on which the parts are to be mounted.

8. The apparatus of claim 1, further comprising a second shuttle which moves the second substrate placed thereon within a predetermined linear section.

9. The apparatus of claim 1, further comprising a driving unit which drives the flipper up and down.

10. The apparatus of claim 1, wherein the first substrate is a wafer and the parts are bare dies formed on the wafer.

11. The apparatus of claim 1, wherein the surface of each of the parts sucked by the first suction nozzles which faces toward one direction is a surface opposite to a surface sucked by the first suction nozzles, and
wherein the one direction is an upward direction.

12. A method of picking up and mounting parts, the method comprising:
picking up parts from a first substrate by sucking the parts using a first pickup unit;
rotating the first pickup unit using a flipper such that a surface of the parts faces upward;
picking up the parts rotated by the flipper by sucking the parts using a second pickup unit; and
mounting the picked-up parts on a second substrate using the second pickup unit.

13. The method of claim 12, wherein the first pickup unit comprises a plurality of first suction nozzles, and the second pickup unit comprises a plurality of second suction nozzles.

14. The method of claim 12, wherein the picking up the parts from the first substrate comprises:
transferring the first substrate to a position, at which the parts are to be sucked, using a first shuttle;
detecting positions of the parts provided on the transferred first substrate using a first detection module of the first pickup unit;
picking up the parts, whose positions have been detected, from the first substrate by sucking the parts using the first pickup unit; and
transferring the first substrate from the position, at which the parts have been sucked, using the first shuttle.

15. The method of claim 12, wherein the parts sucked by the first pickup unit are rotated 180 degrees by the flipper.

16. The method of claim 12, wherein the picking up the parts rotated by the flipper comprises:
moving the second pickup unit to above the first pickup unit;
detecting the positions of the parts sucked by the first pickup unit using a second detection module of the second pickup unit; and
picking up the parts from the first pickup unit by sucking the parts using the second pickup unit.

17. The method of claim 12, wherein the mounting the picked-up parts on the second substrate comprises:
moving the second pickup unit to above the second substrate;
detecting a region of the second substrate on which the parts are to be mounted using the second detection module of the second pickup unit; and
mounting the parts on the region of the second substrate detected by the second detection module.

18. The method of claim 12, further comprising transferring the second substrate having the parts mounted thereon using a second shuttle.

19. The method of claim 12, wherein the first substrate is a wafer and the parts are bare dies formed on the wafer.

20. The method of claim 12, wherein the surface of each of the parts sucked by the first suction nozzles which faces toward one direction is a surface opposite to a surface sucked by the first suction nozzles, and
wherein the one direction is an upward direction.
